(19) United States
(12) Patent Application Publication
(10) Pub. No.: US 2002/0109540 A1
(43) Pub. Date: Aug. 15, 2002

(54) Charge pump transition control between step up and step down operation

(76) Inventor: David D. Meng, Mountain View, CA (US)

Correspondence Address: OPPENHEIMER WOLFF & DONNELLY, LLP, Suite 600, 1620 L Street NW, Washington, DC, 20036, US

(21) Appl. No.: 10/047,716

(22) Filed: Oct. 23, 2001

Related U.S. Application Data
(63) Continuation of application No. 09/369,670, filed on Aug. 5, 1999.

(51) Int. Cl. G05F 1/10

(52) U.S. Cl. 327/536

(57) ABSTRACT

A method (10) and circuit (40) for transition control between step up and step down modes in a charge pump (12). The charge pump (12) starts in an off state (14) and a determination (16) is made if the input voltage is less than or equal to the output voltage. If so, the charge pump (12) is operated (18) in step up mode until it is within regulation. Otherwise, the charge pump (12) is operated (24) in step down mode for at least one cycle. If this brings the charge pump (12) within regulation it is shut down. Otherwise, the charge pump (12) is operated (18) in step up mode until it is within regulation.

### TECHNICAL FIELD

The present invention relates generally to power supplies for electronic systems, and more particularly to efficient control of charge pumps able to transition between step up and step down voltage conversion for use in such power supplies.

### BACKGROUND ART

Electronic circuits today often require power in one or more specific direct current (DC) voltage ranges. To meet such power needs it is typical to convert power from a single source, perhaps a battery or another DC supply already obtained from an alternating current source. Various systems currently exist for power conversion of this nature, including the charge pump. A charge pump is a capacitor and oscillator based circuit which converts a DC input to a DC output which is either higher, lower, or inverted in voltage value.

FIG. 1 (background art) is a schematic depicting a very simple charge pump. Switches (S1 and S2) are controlled by an oscillator (OSC) to alternately charge a flying capacitor (Cx) from an input voltage (V-IN) supplied across an input capacitor (Cin) and to discharge the flying capacitor (Cx) across an output capacitor (Cout), thereby supplying an output voltage (V-OUT). The switches (S1, S2) and the oscillator (OSC) and other controls are commonly all contained in an integrated circuit (IC) today.

Charge pumps can also be used to convert an input voltage (V-IN) to an output voltage (V-OUT) which is alternately both higher and lower in output voltage value. This may be necessary, for example, in a portable electronic device using a 3.3 volt digital integrated circuit and a single cell lithium-ion battery. At full charge such a battery may provide 4.2 volts, yet at near discharge it may provide only 2.5 volts. For a charge pump to consistently provide a 3.3 volt output from such a source it must perform both step up and step down conversion, sometimes also respectively called boost and buck operation.

FIG. 2a-d (background art) are schematics depicting semiconductor switches (N1, N2, P1 and P2, NMOS and PMOS types here) to switch a flying capacitor Cx as follows. FIG. 2a-b are of step down mode operation (buck mode). FIG. 2a is of the charging phase for the flying capacitor (Cx), and FIG. 2b is of the discharge phase. FIG. 2c-d are of step up mode operation (boost mode). FIG. 2c is of the charging phase for the flying capacitor (Cx) in this mode, and FIG. 2d is of the discharge phase. In the charge phase a quanta of energy is loaded from the input, and in the discharge that quanta is transferred to the output.

Unfortunately, while constructing charge pumps capable of transitioning between step up and step down operation is not particularly difficult, as can be seen from the preceding, providing such which can operate efficiently is another matter. Low efficiency can be a severe limitation when using charge pumps with battery and other limited power sources, and inefficiency is generally undesirable. The theoretical efficiency for a charge pump in step up mode operation (frequently also termed 2X mode), i.e., when V-OUT>=V-IN, is V-OUT/(2*V-IN). In step down mode (frequently also termed 1X mode), i.e., when V-OUT<V-IN, the theoretical efficiency is V-OUT/V-IN.

Operation in step down mode therefore provides the highest efficiency, but operation in step up mode provides higher output current capability. In view of these often conflicting goals of efficiency and high current capability, it is advantageous to operate a charge pump in step down mode as long as the output voltage and current requirements can be met, and to otherwise operate it in step up mode. The industry currently widely uses one scheme for this, in step up/down type charge pumps the transition from step up to step down mode is designed to occur when the input voltage is equal to the output voltage plus a preset offset voltage. Since this transition method must be designed for the worst case output current, the offset voltage must be set accordingly, and at light and medium loads this results in a loss in efficiency. It follows that a still better scheme for operating step up/down charge pumps is needed, one which operates more efficiently across a range of output loads from light to heavy.

### DISCLOSURE OF INVENTION

Accordingly, it is an object of the present invention to provide a transitioning system for efficient step up/down mode operation of charge pumps.

Another object of the invention is to provide a transitioning system for step up/down mode operation of charge pumps which works efficiently across a wide range, and preferably the total range, of appropriate output loads.

Another object of the invention is to provide a transitioning system for step up/down mode operation of charge pumps which maintains high efficiency and high output current capability.

And another object of the invention is to provide a system for step up/down mode operation of charge pumps which transitions automatically between such modes in a manner supplying high efficiency or high output current, as may be appropriate for particular output loads.

Briefly, one preferred embodiment of the present invention is a method for operating a charge pump of the type suitable for operating in step up and step down conversion modes to convert an input signal to an output signal of different voltage. The charge pump includes an oscillator from which clock cycles for the use by the invention can be derived. The inventive method starts with charge pump in an off state. A determination is then made whether the voltage of the input signal is less than or equal to that of the output signal. If this is the case, the charge pump is operated in step up mode until it is within regulation, i.e., it is determined that the output signal has reached a desired voltage value. Operation of the charge pump is ceased for at least one clock cycle. Otherwise, if the voltage of the output signal is lower, the charge pump is operated in step down mode for at least one of the clock cycles. If this brings the charge pump within regulation, it is shut down. Otherwise, it is still out of regulation, it is operated in step up mode until it is brought into regulation and then it is shut down.

An advantage of the present invention is that it does provide an efficient, automatically operating transitioning system for step up/down mode operation of charge pumps, one able to accommodate a full range of charge pump output loads.

Another advantage of the present invention is that it may be monolithically implemented. The invention may be incorporated into monolithic integrated circuit type charge pump designs without the need for additional discrete components or resorting to non-monolithic assemblies. The invention may also use discrete components or non-monolithic assemblies, or be integrated into charge pump designs which do so for other purposes, if a designer so wishes.

Another advantage of the present invention is that it may be implemented using widely understood and economical digital integrated circuit level logic.

And another advantage of the invention is that it also reduces output voltage ripple when the output voltage is close to the input voltage with light and medium output load currents.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 (background art) is a schematic of a simple charge pump;

FIG. 2a-d (background art) are schematics respectively of switch operation to operate a charge pump in the charging phase of step down mode, in the discharge phase of step down mode, in the charging phase of step up mode, and in the discharge phase of step up mode;

FIG. 3 is a state diagram of transition between step up and step down operation for a preferred embodiment of the present invention; and

FIG. 4 is a digital logic circuit suitable for implementing the embodiment of FIG. 3.

### BEST MODE FOR CARRYING OUT THE INVENTION

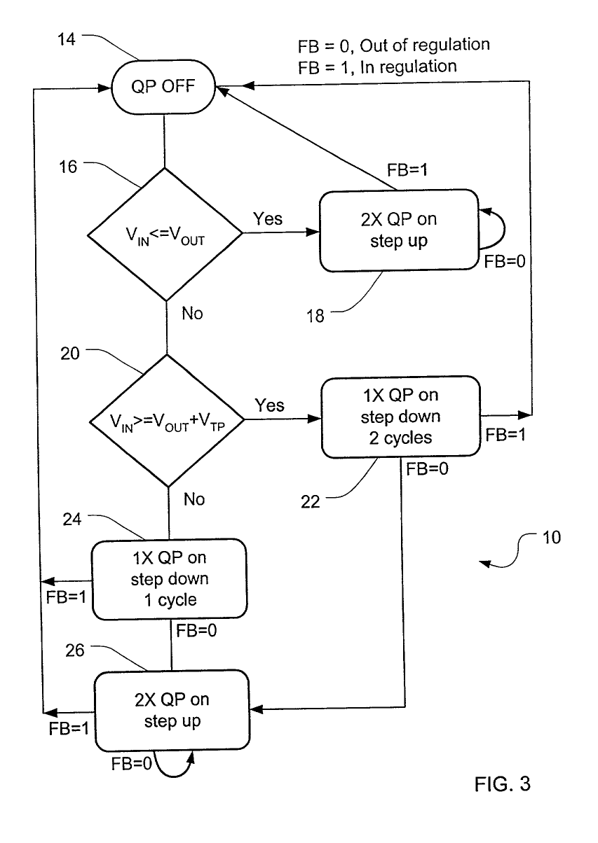

A preferred embodiment of the present invention is a system for charge pump transition control between step up and step down modes of operation. As illustrated in the various drawings herein, and particularly in the view of FIG. 3, a form of this preferred embodiment of the inventive device is depicted by the general reference character 10.

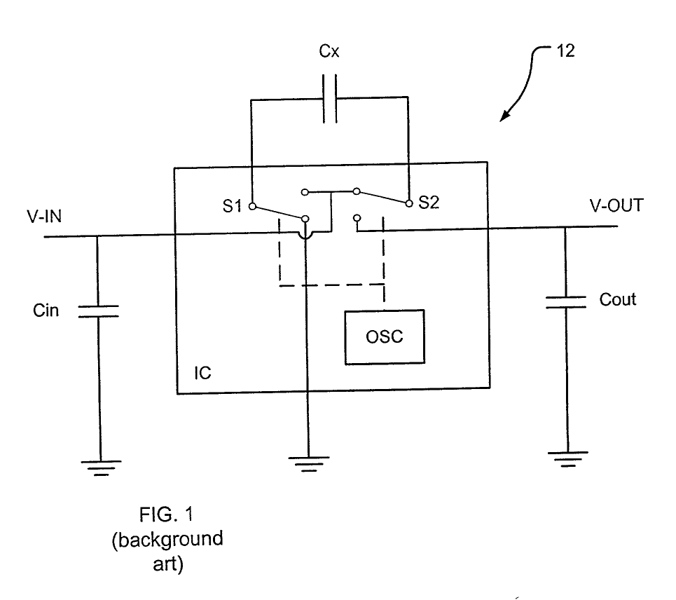

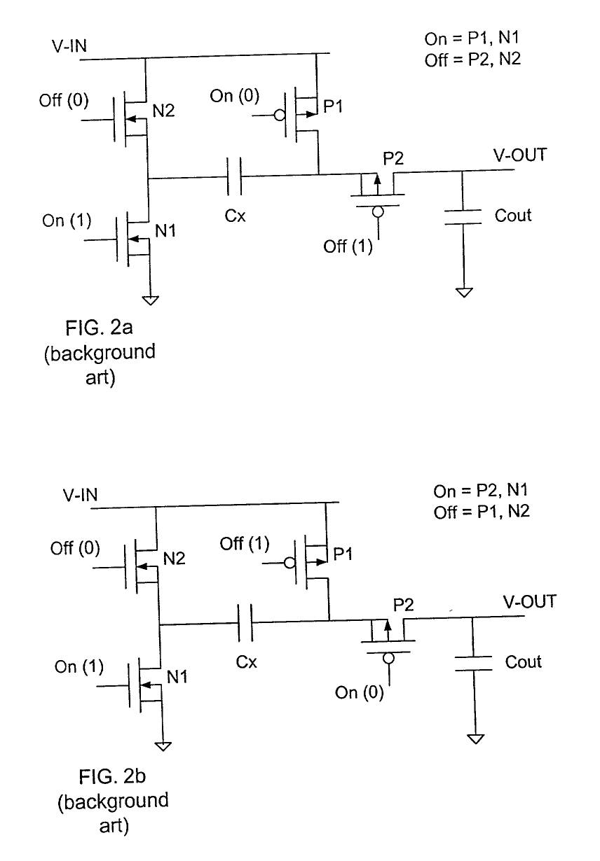

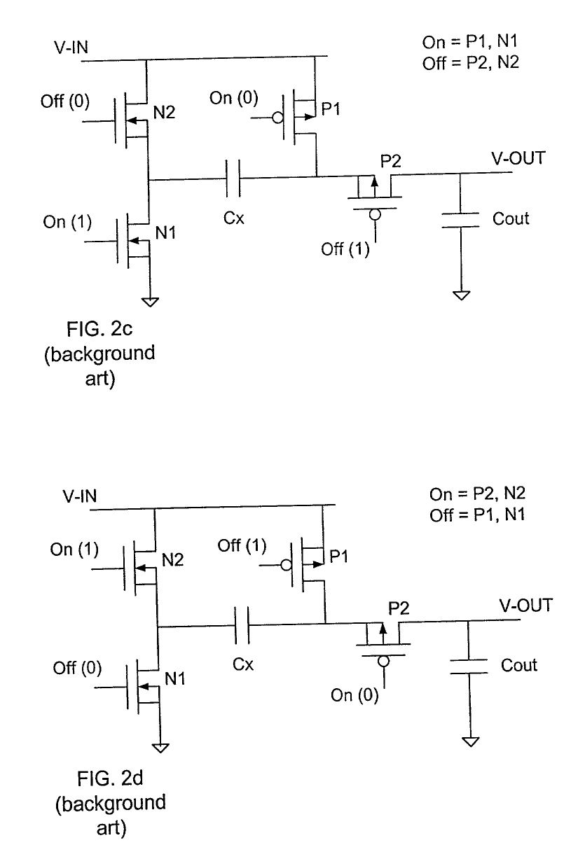

Before describing a preferred embodiment of the inventive transitioning system as applied with an example charge pump 12 (see e.g., FIG. 1 (background art)), some brief theoretical discussion is appropriate. While charge pumps are inherently analog circuits, what is ultimately needed here is a mechanism for choosing between two modes of operation, step up mode and step down mode. This is in addition to the two basic charge pump states of on and off. Viewed from this perspective, the problem has Boolean logic aspects and digital methods may be useful in its solution. Further, since a charge pump employs an oscillator typically operating at a high frequency, a “clock” for use in high speed digital logic is available whenever the charge pump is on. This suggests essentially the following heuristic approach. Try operating a charge pump in efficient step-down mode for one or more clock cycles. If that works, i.e., the output voltage of the charge pump is within a desired range, find the charge pump is efficiently performing its intended task. If that does not work, i.e., the output voltage is not where it is desired, say due to initial start-up or the presence of a heavy load, then operate the charge pump in the less efficient step-up mode. Of course this is quite a simplistic statement of the inventor's approach, and we now provide a more detailed explanation of a preferred embodiment of the inventive transitioning system 10.

FIG. 3 is a state diagram depicting operation of the transitioning system 10. The charge pump 12 starts in an initial step 14, where it is in an off state. In subsequent step 16 a Boolean logic decision is made: Is the input voltage less than or equal to the output voltage (V-IN=<V-OUT)? Depending upon whether this condition evaluates as true or false, a respective step 18 or step 20 is performed next.

In step 18 the charge pump 12 is operated in step up mode for one clock cycle. If V-OUT is then within regulation (FB=1, FB being an acronym for feedback), the charge pump 12 is simply turned off in conventional manner. Alternately, if V-OUT is still out of regulation (FB=0), the charge pump 12 iteratively continues to operate in step up mode for a clock cycle and to re-test regulation, until such time as it is within regulation. Then it turns off. Conceptually this is a repeat-until type of process.

In step 20 a different Boolean logic decision is made: Is the input voltage greater than or equal to the output voltage plus a threshold voltage? This essentially tests for the condition |V-IN|>=|V-OUT|+|V-TP|, wherein the threshold voltage, V-TP, may be about ±0.6 volts. [Having now been pointed out, absolute value considerations should be obvious, depending on the circuitry used, and will be dispensed with.] Depending upon whether this condition evaluates as true or false, a respective step 22 or step 24 is performed next.

In step 22 the charge pump 12 is operated in step down mode for at least one clock cycle. As discussed presently, the inventor prefers two clock cycles here. If V-OUT is then within regulation, the charge pump 12 turns off. Alternately, if V-OUT is still out of regulation, step 26 is proceeded to.

In step 24 the charge pump 12 is operated in step down mode for one clock cycle. If V-OUT is then within regulation, the charge pump 12 turns off. Alternately, if V-OUT is still out of regulation, step 26 is proceeded to.

In step 26 the charge pump 12 is operated in step up mode for one clock cycle. If V-OUT is then within regulation, the charge pump 12 is turned off. Alternately, if V-OUT is still out of regulation, the charge pump 12 iteratively continues to operate in step up mode for a clock cycle and re-test regulation, until such time as it is within regulation. Then it turns off. Conceptually this is also a repeat-until type process.

With continued reference to the state diagram of FIG. 3 it can be appreciated how the transitioning system 10 operates a charge pump in typical situations. On initial circuit start-up, the charge pump is at step 14. The input voltage will be substantially higher than the output voltage (since V-OUT=0), so step 16 will evaluate as false and step 20 will be proceeded to. The input voltage will also generally be higher than the combined output voltage and threshold voltage (V-OUT+V-TP=0+0.6 and V-IN>0.6), and step 20 will therefore evaluate as true and step 22 will be proceeded to. The charge pump 12 is then operated in step down mode for at least one clock cycle. As noted above, the inventor prefers two clock cycles in step down mode in step 22. In situations like this start-up example, the charge pump 12 components can usually handle the heavy current demand of two cycles on then one off. As start-up progresses, assuming the charge pump 12 is not overloaded to begin with, after some number of iterations through steps 14, 16, 20 and 22 the output voltage will raise to the point that step 20 evaluates as false, and initial circuit start-up is essentially complete.

Probably the most typical situation employing the inventive transitioning system 10 will be when the charge pump 12 has been operating, has brought the output voltage within regulation, has accordingly turned off, and the load has subsequently drawn the output voltage down so that it is again out of regulation. The charge pump thus is at initial step 14. At subsequent step 16 there may now be two cases. First, the input voltage can be less than or equal to the output voltage (V-IN<=V-OUT), step 16 evaluates as true, and step 18 is proceeded to because step up operation is appropriate. In step 18 the charge pump 12 then operates in step up mode until back in regulation, and then it turns off. Second, conversely, if step 16 evaluates as false, step 20 is proceeded to because step down operation is appropriate.

At step 20 a decision is made as to what initial duration of step down operation is appropriate. We want to proceed in one manner if the input voltage is substantially greater than the output voltage and we want to proceed differently if otherwise. As noted above, the inventor's preferred test for determining this is to test whether the input voltage is greater than or equal to the output voltage plus a threshold voltage (V-TP). The preferred threshold voltage (V-TP) is the voltage drop across one PMOS semiconductor junction (thus the “P” in the V-TP acronym used herein). The threshold voltage is therefore approximately 0.6 volts when conventional materials are used.

If the voltage difference is substantial, in step 22 the charge pump 12 is operated in step down mode and regulation is tested. The inventor prefers to operate in step down mode here for two clock cycles before testing regulation, but this is not a necessary requirement. If the output is now within regulation, the charge pump 12 has done its job for now and it turns off (goes to step 14). But if the output is not within regulation, it is time to instead resort to step up mode (by going to step 26). Step up mode is inefficient but it can provide the high current necessary to either correct the out of regulation situation quickly or to better handle a heavy output load.

Alternately, if the voltage difference is not substantial, in step 24 the charge pump 12 is operated in step down mode and regulation is tested. Here the inventor prefers to operate in step down mode for one clock cycle before testing regulation, but this also is not a necessary requirement and larger numbers of clock cycles may be used in alternate embodiments. If the output is now within regulation, the charge pump 12 has done its job fully and it turns off (goes to step 14). But if the output is not within regulation, it is here also time to resort to step up mode by going to step 26.

As can be appreciated from the preceding, inefficient step up mode is only used when truly needed, i.e., when first starting up, to quickly resume regulation, and to provide high output current.

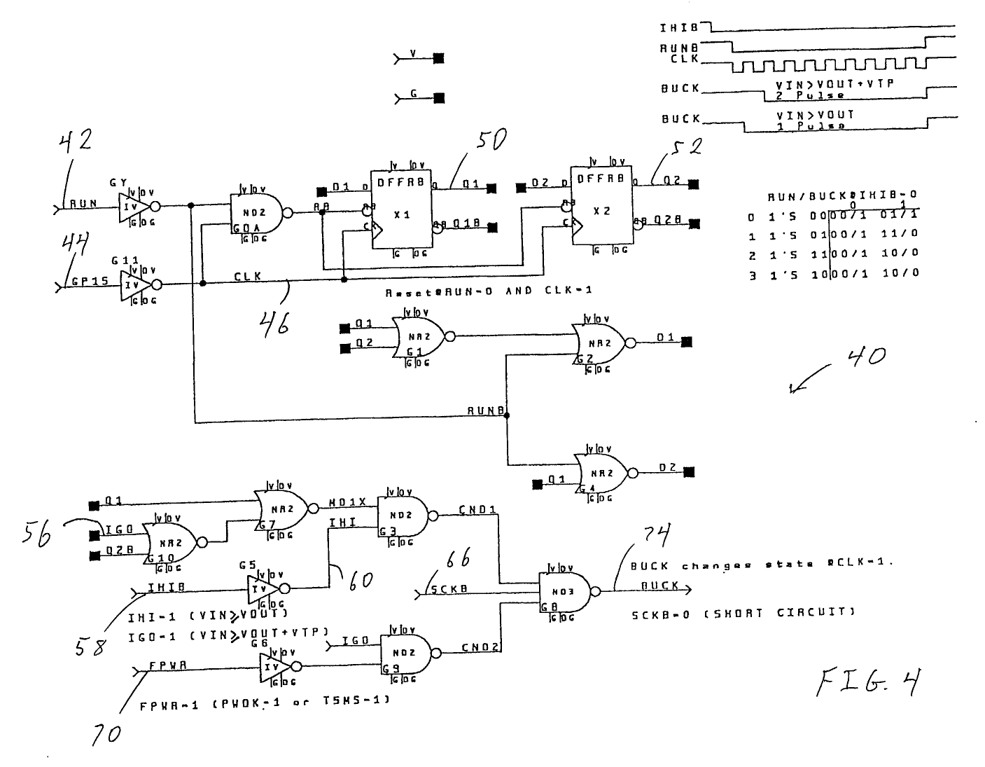

FIG. 4 is a digital logic circuit 40 suitable for implementing the embodiment of FIG. 3. While some of the signal labels here are self-explanatory, others bear some explanation. A “B” suffix indicates “bar” or not. For example, flip-flop X1 produces Q1 and opposite Q1B outputs. The RUN signal 42 (RUN=1) indicates that it is desirable to operate the charge pump 12 because of an out of regulation situation (FB=0). Conversely, RUN=0 indicates it is not desirable to operate, i.e., an in regulation situation (FB=1). The GP1S signal 44 is taken from the gate of one of the switches used to switch the flying capacitor in the charge pump 12, buffered and inverted to create the CLK signal 46, which is used to clock the logic circuit 40. Typically the GP1S signal 44 will be above one mega Hertz (Hz), depending upon the oscillator frequency of the underlying charge pump 12, from which it will usually be derived. The Q1 signal 50 and Q2 signal 52 are internal states of the logic circuit 40. They can, respectively have values of 0,0; 0,1; 1,0; and 1,1. The IGO signal 56 is true (IGO=1) when V-IN>=V-OUT+V-TP. The IHIB signal 58 (IHI bar, i.e., not IHI) is then buffered and inverted to create the IHI signal 60, wherein IHI=1 is the case when V-IN>=V-OUT. The SCKB signal 66 indicates a short circuit when SCKB=0. Short circuit protection is not part of the invention, but taking its occurrence into account is desirable. Similarly, the FPWR signal 70 is also not part of the invention here. The input Full Power (FPWR) is 1 when power is OK (PWOK=1) or when a 2 milli second soft start (T2MS=1) is complete. The purpose of the logic circuit is to derive the BUCK signal 74. When BUCK=1, step down mode (1X) is desired. When BUCK=0, step up mode (2X) is desired.

The above description is of the inventor's preferred embodiment, but other embodiments of the transitioning system 10 are possible. For example, with reference again to FIG. 3, a simpler embodiment might eliminate step 20 and step 22. In this embodiment, the paths from step 22 would not exist and when step 16 evaluated to false, step 24 would be proceeded to.

The inventive transitioning system 10 is efficient, but it can provide other benefits as well. In charge pumps where the oscillator frequency is user selectable, as is sometimes desirable to avoid particular frequencies of output ripple or inductive emission that might disrupt attached or nearby circuitry, the CLK signal 46 of the invention will typically be the same and no additional frequency related concerns need arise. Further, the transitioning system 10 produces lower charge pump output ripple. For example, to convert a four volt input voltage to a three volt output voltage a prior art step up/down mode transitioning system might produce 40-50 milli volts (mV) of ripple, whereas an equivalent embodiment employing the transitioning system 10 would produce, roughly only 20 mV.

In addition to the above mentioned examples, various other modifications and alterations of the inventive transitioning system 10 may be made without departing from the invention. Accordingly, the above disclosure is not to be considered as limiting and the appended claims are to be interpreted as encompassing the true spirit and the entire scope of the invention.

### INDUSTRIAL APPLICABILITY

The use of charge pumps is increasingly desirable to meet our society's growing dependence on systems employing electronics circuits, particularly when those circuits must be small, light weight, or battery operated. They can flexibly receive direct current input power across ranges of voltage and convert it to direct current output power to accommodate varying output loads. Step up/down type charge pumps, of present interest, are particularly able to do this using wide ranges of input voltage. Charge pumps may be made large or small, in assemblies ranging from discrete component to monolithic integrated circuit based embodiments. They also use economical and otherwise desirable components, notably using capacitors rather than inductors. Employing charge pumps is also well, or at least easily, understood by circuit designers.

However, charge pumps have some disadvantages. Somewhat contrary to popular belief, they are not particularly efficient. Further, due to their oscillator based nature and the current flow as they transfer charge quanta from capacitive input to output reservoirs, they can produce undesirable output voltage ripple.

The present transitioning system 10 is well suited for application in step up/down charge pumps because it addresses both of the above noted disadvantages. The inventive transitioning system 10 is more efficient than prior transition systems in step up/down charge pumps, and it concurrently reduces output voltage ripple for mid through low loads. These advantages will permit application of charge pumps employing the present transitioning system 10 in a broader range of applications, as well as provide benefits in existing applications. Some larger, heavier, inductor based power conversion means may now be replaced with charge pumps, permitting smaller, lighter and otherwise improved overall systems. Where step up/down type charge pumps have already been used, they may now be more efficient. This is particularly important for battery powered circuits, wherein use of the inventive transitioning system 10 will permit obtaining longer use before disposable batteries must be replaced or rechargeable ones must be charged.

The present transitioning system 10 is also relatively easily and economically implemented. It may employ discrete or integrated circuit techniques, and in the case of the latter it may be monolithically implemented. It requires no particular expensive or additional material, being includable in some charge pump integrated circuits with effectively no increase in material cost. The transitioning system 10 can also use well and widely understood digital logic principles. In sum, once the principles of the invention herein disclosed are appreciated, its implementation should pose no particular problems to those of reasonable skill in the electronics arts.

For the above, and other, reasons, it is expected that the transitioning system 10 of the present invention will have widespread industrial applicability. Therefore, it is expected that the commercial utility of the present invention will be extensive and long lasting.

| | |
|---|---|
| 10 | transitioning system |
| 12 | charge pump |
| 14-26 | steps |
| 40 | logic circuit |
| 42 | RUN signal |
| 44 | GP1S signal |
| 46 | CLK signal |
| 50 | Q1 signal |
| 52 | Q2 signal |
| 56 | IGO signal |
| 58 | IHIB signal |
| 60 | IHI signal |
| 66 | SCKB signal |
| 70 | FPWR signal |
| 74 | BUCK signal |

What is claimed is:

1. A method for operating a charge pump to convert an input signal to an output signal, wherein the charge pump includes an oscillator producing clock cycles and the charge pump is of the type suitable for operating in more than one conversion mode, the method comprising the steps of:
(a) determining if the output signal is not at a desired voltage:
(b) if said step (a) is true:
(c) determining if transition between a first of the conversion modes and a second of the conversion modes is permissible, wherein operation of the charge pump in said first of the conversion modes is preferable;
if said step (c) is true, then operating the charge pump in said first of the conversion modes, for at least one of the clock cycles, until the voltage of the output signal reaches said desired voltage, and then ceasing to operate the charge pump for at least one of the clock cycles;
if said step (c) is false, then operating the charge pump in said second of the conversion modes for at least one of the clock cycles, and:
if the voltage of the output signal reaches said desired voltage, then ceasing to operate the charge pump for at least one of the clock cycles;
if the voltage of the output signal is not said desired voltage, then operating the charge pump in said first of the conversion modes until the voltage of the output signal reaches said desired voltage, and then ceasing to operate the charge pump for at least one of the clock cycles.

2. The method of claim 1, wherein said first of the conversion modes is preferable because it is more efficient to operate the charge pump in said first of the conversion modes.

3. A method for operating a charge pump to convert an input signal to an output signal, wherein the charge pump includes an oscillator producing clock cycles and the charge pump is of the type suitable for alternately operating in a step up mode such that conversion produces higher voltage in the output signal than in the input signal or operating in a step down mode such that conversion produces lower voltage in the output signal than in the input signal, the method comprising the steps of:
(a) determining if the voltage of the input signal is less than or equal to the voltage of the output signal;
(b) if said step (a) is true, then operating the charge pump in the step up mode, for at least one of the clock cycles, until the voltage of the output signal reaches a desired voltage, and then ceasing to operate the charge pump for at least one of the clock cycles;
(c) if said step (a) is false, then operating the charge pump in the step down mode for at least one of the clock cycles, and:
if the voltage of the output signal reaches said desired voltage, then ceasing to operate the charge pump for at least one of the clock cycles;
if the voltage of the output signal is not said desired voltage, then operating the charge pump in the step up mode until the voltage of the output signal reaches said desired voltage, and then ceasing to operate the charge pump for at least one of the clock cycles.

4. The method of claim 3, wherein said step (c) comprises:
(d) if said step (a) is false, determining if the voltage of the input signal is greater than or equal to the voltage of the output signal plus a predefined threshold voltage;
(e) if said step (d) is true, then operating the charge pump in the step down mode, for at least one of the clock cycles, and:
if the voltage of the output signal reaches said desired voltage, then ceasing to operate the charge pump for at least one of the clock cycles;
if the voltage of the output signal is not said desired voltage, then operating the charge pump in the step up mode until the voltage of the output signal reaches said desired voltage, and then ceasing to operate the charge pump for at least one of the clock cycles;
(f) if said step (d) is false, then operating the charge pump in the step down mode for at least one of the clock cycles, and:
if the voltage of the output signal reaches said desired voltage, then ceasing to operate the charge pump for at least one of the clock cycles;
if the voltage of the output signal is not said desired voltage, then operating the charge pump in the step up mode until the voltage of the output signal reaches said desired voltage, and then ceasing to operate the charge pump for at least one of the clock cycles.

5. The method of claim 4, wherein in said step (e) the charge pump is operated in the step down mode for two of the clock cycles.

6. The method of claim 4, wherein:
in said step (b) the charge pump is operated in the step up mode for one of the clock cycles;
in said step (e) the charge pump is operated in the step down mode for two of the clock cycles; and
in said step (f) the charge pump is operated in the step down mode for one of the clock cycles.

7. The method of claim 4, wherein in said step (d) said predefined threshold voltage is less than or equal to a PMOS threshold voltage drop, to limit input current during startup of the charge pump.

8. A circuit for controlling operation of a charge pump of the type suitable for operating in more than one conversion mode, wherein the charge pump includes an oscillator producing clock cycles and a detector suitable for indicating whether the voltage of the output signal of the charge pump is within regulation, the circuit comprising:
a sensor able to determine if transition between a first of the conversion modes and a second of the conversion modes is permissible, wherein operation of the charge pump in said first of the conversion modes is preferable;
a control sub-circuit able to operate the charge pump in said first of the conversion modes for at least one of the clock cycles when the charge pump is not within regulation, until the charge pump is within regulation, and then ceasing operation of the charge pump for at least one of the clock cycles;
said control sub-circuit further able to operate the charge pump in said second of the conversion modes for at least one of the clock cycles when the charge pump is not within regulation, and:
if the charge pump is then within regulation, ceasing operation of the charge pump for at least one of the clock cycles;
else, operating the charge pump in said first of the conversion modes mode until the charge pump is within regulation and then ceasing operation of the charge pump for at least one of the clock cycles.

9. The circuit of claim 8, wherein said first of the conversion modes is preferable because it is more efficient to operate the charge pump in said first of the conversion modes.

10. The circuit of claim 8, wherein said control sub-circuit comprises a plurality of digital logic gates.

11. The circuit of claim 8, wherein the charge pump includes an integrated circuit and said control sub-circuit is integrated into said integrated circuit.

12. The circuit of claim 11, wherein the sensor is also integrated into said integrated circuit.

13. A circuit for controlling transition of a charge pump between step up operation and step down operation, wherein the charge pump includes an oscillator producing clock cycles and a detector suitable for producing a regulation signal indicating whether the voltage of the output signal of the charge pump is sufficiently close to a preset desired output voltage value to be considered to be within regulation, the circuit comprising:
a first comparator suitable for producing a first comparison signal defined to be true when the voltage of the input signal is less than or equal to the voltage of the output signal;
a sub-circuit suitable for:
receiving the regulation signal and said first comparison signal;
when said first comparison signal is true, operating the charge pump in step up mode, for at least one of the clock cycles, until the charge pump is within regulation, and then ceasing operation of the charge pump for at least one of the clock cycles;
when said first comparison signal is not true, then operating the charge pump in step down mode for at least one of the clock cycles, and:
if the charge pump is within regulation, then ceasing operation of the charge pump for at least one of the clock cycles;
else, operating the charge pump in step up mode until the charge pump is within regulation and then ceasing operation of the charge pump for at least one of the clock cycles.

14. The circuit of claim 13, further comprising:
a second comparator suitable for producing a second comparison signal defined to be true when the voltage of the input signal is greater than or equal to the voltage of the output signal plus a predetermined threshold value;
said sub-circuit further suitable for:
receiving said second comparison signal;
when said first comparison signal is not true but said second comparison signal is true, then operating the charge pump in step down mode, for at least one of the clock cycles and:
if the charge pump is within regulation, then ceasing operation of the charge pump for at least one of the clock cycles;
else, operating the charge pump in step up mode until the charge pump is within regulation and then ceasing operation of the charge pump for at least one of the clock cycles; and
when said first comparison signal and said second comparison signal are both not true, then operating the charge pump in step down mode for at least one of the clock cycles, and:
if the charge pump is within regulation, then ceasing operation of the charge pump for at least one of the clock cycles;
else, operating the charge pump in step up mode until the charge pump is within regulation and then ceasing operation of the charge pump for at least one of the clock cycles.

15. The circuit of claim 14, wherein said logic sub-circuit operates the charge pump in step down mode for two of the clock cycles when it first determines that said first comparison signal is not true but said second comparison signal is true.

16. The circuit of claim 14, wherein said predetermined threshold value is less than or equal to the voltage drop across one semiconductor junction.

17. The circuit of claim 14, wherein said predetermined threshold value is derived from a PMOS threshold voltage drop.

18. The circuit of claim 14, wherein said first comparator, said second comparator, and said sub-circuit collectively comprise a plurality of digital logic gates.

19. The circuit of claim 13, wherein said sub-circuit comprises a plurality of digital logic gates.

20. The circuit of claim 13, wherein the charge pump includes an integrated circuit and the circuit is integrated into said integrated circuit.
